(19) United States
(12) Patent Application Publication
(10) Pub. No.: US 2004/0196312 A1
(43) Pub. Date: Oct. 7, 2004

(54) Method and apparatus for rapid distribution of information

(76) Inventors: Joseph Powers, North Brunswick, NJ (US); William Rehm, Lebanon, NJ (US)

Correspondence Address: Gregory S. Bernabeo, Esq., Synnestvedt & Lechner LLP, 2600 Aramark Tower, 1101 Market Street, Philadelphia, PA, 19107-2950, US

(21) Appl. No.: 10/408,867

(22) Filed: Apr. 7, 2003

(51) Int. Cl. G09G 5/00

(52) U.S. Cl. 345/753

(57) ABSTRACT

A method and apparatus for rapid distribution of information whereby information gathered from an ongoing conference is incorporated into a single, electronic file. The file may be an interpretable data file, or a personal digital assistant (PDA)-executable application file created to include both the information sought to be distributed, and viewer software for displaying the information via a PDA device. The application file may be created from an easily-created document through a GUI-driven software application for gathering information from a user, manipulating data, and interacting with commercially available code development software, which typically requires a high level of user experience or training, to automate the otherwise complex application development process. The application file may include a checksum to prevent distribution and/or display of altered information. The file is distributed at the conference via wireless transmission to attendees' PDA devices via a beaming station.

### FIELD OF THE INVENTION

The present invention relates generally to electronic devices, such as a personal digital assistant (PDA) or other computing device, and particularly to use of such devices for distribution of information.

### DISCUSSION OF RELATED ART

Data, graphical, textual and other types of information, such as substantive or promotional/advertising materials, are often distributed in paper form, e.g. by manual distribution of printed paper copies. For example, large volumes of information are often distributed at medical, dental, sales, legal or other conferences to conference attendees. Receipt, management and reference to such large volumes of information can be cumbersome, which leads to non-use and thereby renders such materials ineffective.

Large volumes of information can be stored electronically, in digital form, in computing devices. Many individuals now carry and use personal digital assistant (PDA) computing devices, such as a Palm® handheld computing device manufactured and/or distributed by Palm, Inc. of Malpitas, Calif., U.S.A., or similar PDA device running Palm® OS or Microsoft® Windows OS software, or other similar compact, portable computing devices, such as tablet computers, notebook computers, etc. (collectively, PDA device).

Distributors of information have found it desirable to distribute, in electronic form for storing and viewing on a PDA device, information of types formerly distributed in paper form. For example, some conference organizers have specially configured PDA devices in advance of a conference to store information desired to be distributed, and then subsequently distributed the specially configured PDA devices to conference attendees, with or without associated rental or purchase fees. This often requires specially configuring the PDA devices to store specialized stand-alone viewer software for displaying the information via the PDA device (e.g. to provide Adobe® Acrobat® viewer software, manufactured and/or distributed by Adobe Systems, Inc. of San Jose, Calif., U.S.A., when the information is in a *.pdf formatted data file that is interpretable and displayable by the Adobe® Acrobat® viewer software). However, this is cumbersome, expensive, may require license fees for the viewer software, and requires significant memory space to provide the desired functionality.

Additionally, some conference organizers have begun to distribute information prepared in advance of a conference to conference attendees at conference events by specially configuring attendees' own PDA devices. In a typical arrangement, an electronic data file storing the information is distributed directly to conference attendees' PDA devices via beaming stations physically located in or near an auditorium, etc. in which the conference is held. For example, such a method for distribution of information has been used to distribute information to physicians and other attendees of medical conferences.

Beaming stations are well-known in the art. An example of such a beaming station is the Clarinet ESB 1000 beaming station manufactured and/or distributed by Clarinet Systems, Inc. of San Jose, Calif., U.S.A. As well known in the art, such beaming stations use short-range wireless (infra-red (IR)) transmission to transmit an electronic file stored on the beaming station to any compatible PDA devices that are within operable proximity thereto, e.g. typically within approximately one to ten feet in range. Such beaming stations are typically initially programmed by providing the desired data file to the beaming station, e.g. by a wired connection or a wireless beaming transmission. The beaming station is then operable to repeatedly transmit the electronic file, and any transmission-ready PDA devices within operative range receive that file. Most commercially available PDA devices are configured to receive, or can be configured to receive, such wireless “beaming” transmissions. It should be noted that other short range wireless technologies may be used and are contemplated herein as within the scope of a beaming station.

It is relatively straight-forward to transmit an electronic file to a PDA via a beaming station. However, as a practical matter, such a method of distribution of information is cumbersome because the receiving PDA devices may not have viewer software compatible with the electronic file's format, and therefore be unable to display the information sought to be distributed. Such viewer software may have to be obtained by the attendee at a later date, and possibly at a cost to the attendee. Additionally, it is often possible to edit information distributed in this manner, and for the attendee to then retransmit the edited information to another's PDA device. While such viral-type retransmission is generally desirable because it promotes widespread distribution of the information, it is undesirable to permit editing of the information, which could result in dissemination of inaccurate information, that could be harmful to people, e.g. when the information relates to medical diagnosis, treatment, medication dosages, etc.

### SUMMARY OF THE INVENTION

The present invention provides a method and apparatus for rapid distribution of information whereby information content including information gathered from an ongoing conference is incorporated into an electronic file that includes such information content. In other words, the file includes information content taken from the conference while the conference is occurring and/or after the conference has occurred, which allows for inclusion of information that could not be gathered before the conference, e.g. contemporaneous photographic images, etc. The file is then distributed at the conference via wireless transmission to attendees' personal digital assistant (PDA) devices, e.g. via a beaming station. In this manner, the method allows for creation of such a file in real-time so that up-to-date information may be included and distributed during the conference, etc. thereby eliminating the need to develop such content before a conference and associated problems relating to changes in scheduling, content, speakers, etc. Accordingly, the most current information can be gathered for distribution and be rapidly distributed in a timely manner.

In one embodiment, the file is a PDA-executable application file created to include both the information content sought to be distributed, and viewer software configured to display the information content via a PDA device for viewing by a conference attendee, etc. This eliminates any problems associated with beaming of multiple files (e.g. a data file and a viewer software file) sharing of the information content with conference attendees, sharing the information content among attendees and non-attendees, etc.

In a preferred embodiment, the application file is created through a novel GUI-driven software application, and includes a checksum or other file integrity check to ensure that the original file has not been altered before initial or subsequent distribution, to preserve the integrity of the information content. The GUI-driven software application acts as a user-friendly interface to gather information from a user, and to manipulate data in preparation for compiling by commercially available, stand-alone, software code development software that typically requires a high level of user experience/training and/or is not user-friendly for someone other than a professional code developer.

### BRIEF DESCRIPTION OF THE DRAWINGS

The present invention will now be described by way of example with reference to the following drawings in which:

FIG. 1 is a diagram of an exemplary system and environment for implementing the present invention;

FIG. 2 is a flow diagram of an overview of an exemplary method for rapid distribution of information in accordance with an exemplary embodiment of the present invention;

FIG. 3 is a flow diagram of an exemplary method for delivering a file to a beaming station in accordance with the method of FIG. 2;

FIG. 4 is a flow diagram illustrating an overview of an exemplary method of application file development for distribution in accordance with the method of FIG. 2;

FIG. 5 is an image of an exemplary document created with prior art word processor software;

FIG. 6 is an image showing exemplary HTML source code created by the word processor software for the exemplary document of FIG. 5;

FIG. 7 is a flow diagram illustrating an exemplary method for GUI-driven application development in accordance with FIG. 4;

FIGS. 8 and 9 are images of exemplary GUI windows for receiving input in accordance with the method of FIG. 7; and

FIGS. 10 and 11 show an exemplary PDA device displaying information content created in accordance with FIGS. 5-9.

### DETAILED DESCRIPTION

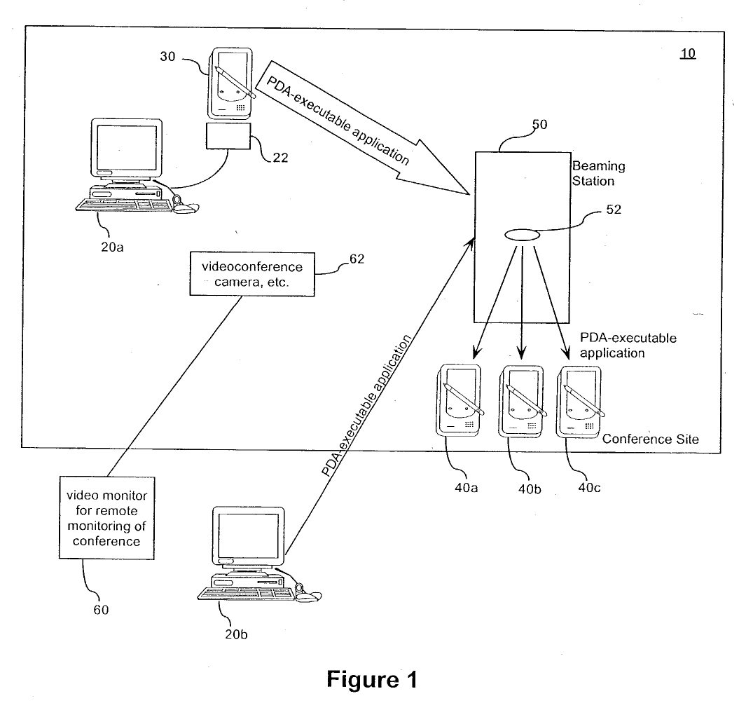

The present invention provides a method an apparatus for rapid distribution of information, which may be understood with reference to the system and exemplary environment of FIG. 1. In the example of FIG. 1, the system is implemented in a conference site environment 10, e.g. in a conference center auditorium hosting a medical conference for physicians. An individual practicing the present invention at the conference site 10 may attend the conference, listen to speakers, view presentations, take photographs of the conference, etc. to gather information from the conference. In one embodiment, a laptop, desktop or other conventional personal computer 20a at the conference site is used by the attendee to create information content embodied in an electronic file, as discussed in detail below. In another embodiment, an individual may participate in the conference by viewing the conference via a video monitor 60 outside the conference site 10 to observe an audiovisual feed captured by a video camera 62 provided at the conference site 10, and then use a remotely located personal computer 20b to create information content embodied in an electronic file. The file is then transmitted via a wired and/or wireless transmission to a beaming station 50 servicing conference attendees, e.g. in the auditorium, outside the auditorium, in a hotel servicing the auditorium, etc. Conference attendees or others may then download the file from the beaming station 50 via a port 52 (e.g. and IR port) to their respective PDA devices 40a, 40b, 40c to view the information content.

The present invention is somewhat similar to a known method that involves providing a beaming station at a conference site that is configured to transmit a data file including information compiled before a conference to PDA devices of conference attendees. However, the present invention involves transmission of a PDA Operating System (OS) compatible file created concurrently with and/or after the conference, and the file includes information gathered from the conference as/after it occurs. In this manner, the method provides for creation of such a file in real-time, e.g. during the conference, so that up-to-date information may be included and distributed during and/or concurrently with the conference. This eliminates the need to develop such content before a conference and associated problems relating to availability of information and changes in scheduling, content, speakers, etc. that cannot be determined before the conference actually occurs. Accordingly, the most current information content can be created for distribution and rapidly distributed in a timely manner.

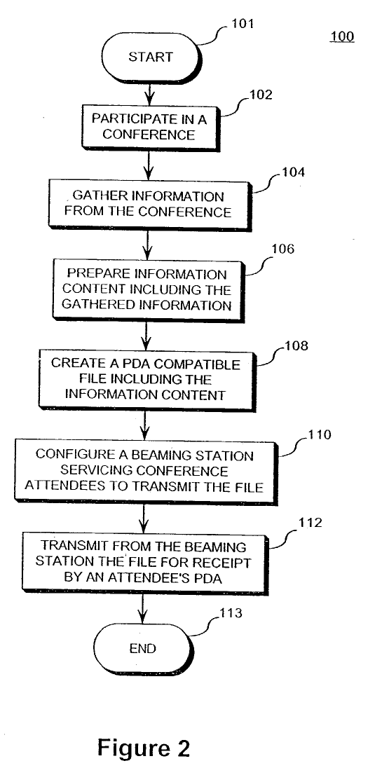

FIG. 2 is a flow diagram 100 of an overview of an exemplary method for rapid distribution of information in accordance with an exemplary embodiment of the present invention. As shown in FIG. 2, the method starts with participation in a live/ongoing conference, as shown at steps 101 and 102, e.g. by attending the conference at the conference site 10 of FIG. 1, or by viewing the conference via a video monitor 60 at a location remote from the conference/auditorium, etc., as shown in FIG. 1. In this manner, a conference participant practicing the present invention may obtain information from the ongoing conference.

Next, the participant gathers information obtained from the conference, as shown at step 104. The information gathered is the information that is desired to be distributed to the conference attendees, and may include, for example, notes, copies of slides from a slide presentation, maps, agendas, announcements regarding changes in scheduling, speakers, times, locations, etc. By way of further example, the information may include photographs or other images, audio and/or video captured/recorded during the ongoing conference, as it occurs.

Information content is then prepared, as shown at step 106. This step involves putting the information in appropriate electronic form, e.g. by scanning, typing, formatting, editing, etc. For example, this may be achieved by using the personal computer 20a, 20b (FIG. 1) (or other general purpose computing device) running appropriate scanning, image editing, word processor and/or other software.

Next, a PDA-compatible electronic file is created that includes the information content, as shown at step 108. This is also achieved using computer 20a, 20b, and may require compilation, formatting, etc. In one embodiment, the file is a specially formatted data file that is PDA Operating System (OS) compatible, i.e. is compatible with a PDA-executable viewer software application for interpreting and displaying data files in a corresponding format. For example, the information content may be embodied in a Portable Document File (*.pdf) formatted data file that may be interpreted and displayed by Adobe® Acrobat® viewer software for displaying *.pdf format data files via a PDA. By way of further example, the personal computer may be provided with word processor software for creating textual and/or hypertext markup language (HTML) documents, etc. In such an embodiment, the PDA must already have installed, or subsequently have installed, the appropriate viewer software (embodied in a separate file) to view the information content.

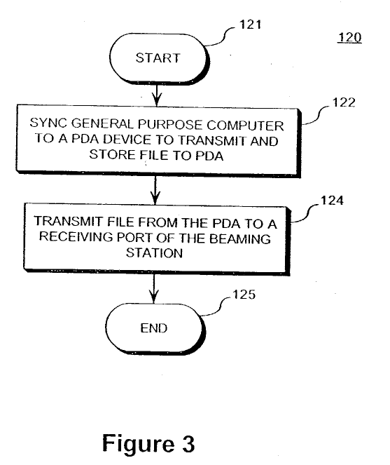

Next, a beaming station 50 (FIG. 1) that is provided to service attendees of the conference is configured to transmit the file for receipt by attendees PDA devices, etc., as shown at step 110. In an embodiment in which the file is a PDA-executable application as described above, this step involves synchronizing the personal computer 20a to a PDA-device via a synchronization cradle 22, as well known in the art, to copy the application file onto the PDA, as shown at step 122 of FIG. 3, and then transmitting the PDA-executable application file from the PDA to a receiving port of the beaming station 50, as shown at step 124 of FIG. 3. For example, this may be performed via a conventional wireless “beaming” operation of the type well known in the art. At this point, the beaming station 50 is configured to transmit the PDA-executable application file. In an alternative embodiment, a direct, wired connection may be provided between the personal computer 20b (FIG. 1) and the beaming station 50 for transmitting the PDA-executable application file, provided the beaming station 50 has such capability.

The file created to include the information gathered from the conference is then distributed by transmitting the file to PDA devices for use by conference attendees or others, as shown at steps 112, 113 of FIG. 2. For example, this may be performed by causing the beaming station to repeatedly transmit the file so that any transmission-ready PDA devices within operative range will receive the file, as known in the art.

In this manner, the method of the present invention provides for creation of a file in real-time, e.g. during the conference, to include information gathered from/during the conference so that up-to-date information may be included and rapidly distributed during and/or concurrently with the conference, thereby eliminating the need to develop such content before a conference, and associated problems relating to availability of information.

In another embodiment of FIG. 2, the file created in step 108 is a PDA-executable application file that includes not only information content embodying information taken from the conference, but also viewer software for displaying the information content via the PDA device. In this manner, a single file is executable to display the information content embodied in the executable application file, and no optional/additional software needs to be installed on an operable PDA device, only basic operating system software, such as Palm® OS. The file is therefore a single, stand-alone file that is easily transmitted via a beaming station, and is easily shared among PDA users without fear of compatibility, availability of viewer software, use problems, etc. In such an embodiment, the present invention involves providing a personal computer at a conference site 10 or remotely 20a, 20b that is capable of creating a PDA-executable application file. For example, such a personal computer may be specially configured with appropriate commercially available code development software, such as Code Warrior® software manufactured and/or distributed by Metrowerks, Inc. of St-Laurent, Quebec, Canada, which is known in the art for developing executable application programs in the C/C++ programming languages and compiling them to *.prc Palm® OS executable format. This software typically requires a professional software developer, and/or a team of such individuals, to expedite the typically lengthy application development process, in view of the intended rapid distribution of information. While effective, employment of one or more of such professionals can be undesirably expensive.

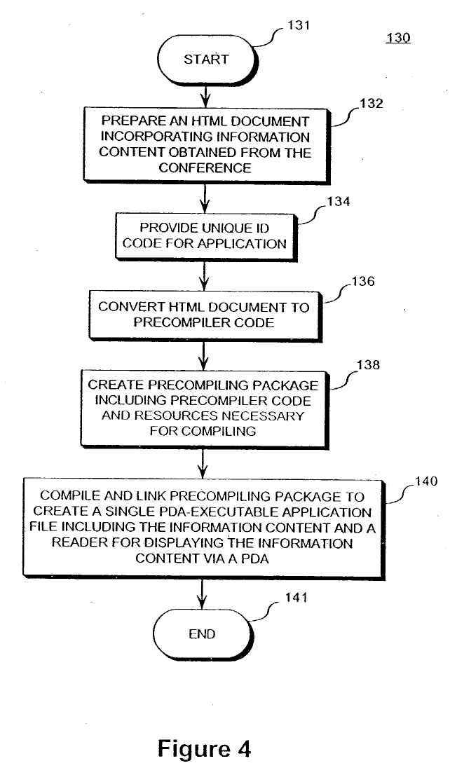

FIGS. 4-11 illustrate exemplary PDA-executable application development suitable for distribution in accordance with a preferred embodiment of the method of FIG. 2. In FIGS. 4-11, a specially configured graphical user interface (GUI) or other interface is provided to gather information from a participant, and to act as an automated software assistant to perform tasks otherwise performed by a professional software developer and/or to manipulate data and interact with commercially available code development software to develop the PDA-executable application. In this manner, the participant can be guided through the complex application development process by interacting with a simple “wizard” type interface, allowing computer users to develop PDA-executable software applications without software programming experience. Additionally, the present invention permits a participant to use user-friendly authoring tools, such as word processor software, to create information content for distribution, manipulates the format of such information content to a format compatible with commercially available code development software, and then interacts with such code development software to automatedly compile and link to develop a PDA-executable application for viewing information content, thereby eliminating the need for a professional software developer.

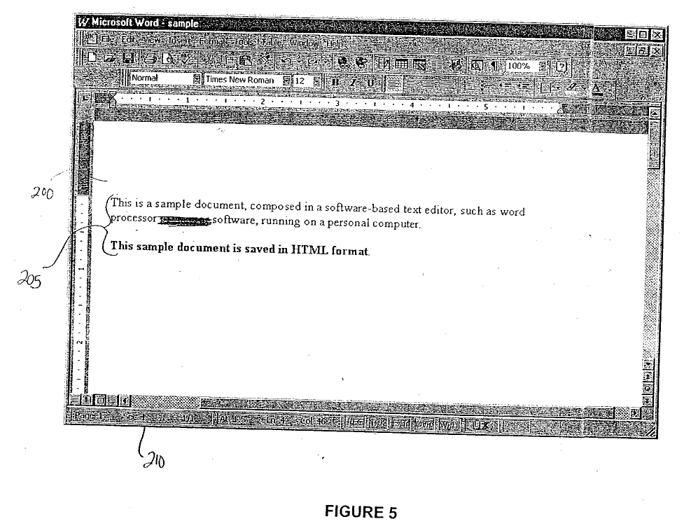

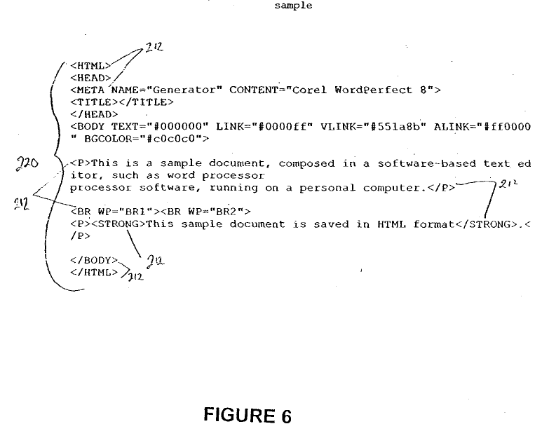

FIG. 4 shows a flow diagram 130 illustrating an overview of a method of the present invention. As shown in FIG. 4, the method involves preparing an HTML document incorporating information content gathered from the conference, as shown at steps 131, 132. For example, the HTML document may be prepared using conventional word processor software, such as Microsoft® Word word processing software manufactured and/or distributed by Microsoft, Inc. of Redmond, Wash., U.S.A., running on a conventional desktop or laptop personal computer 20a, 20b (FIG. 1). FIG. 5 shows an exemplary document 200 created in a word processor and displayed in a word processor GUI window 210 of a type known for window-based operating systems, such as the Microsoft® Windows operating system software manufactured and/or distributed by Microsoft, Inc. The document 200 includes exemplary textual information content 205. By creating a document while using the word processor in a usual manner, e.g. to include typed text, copied images, etc., an HTML document can be created by using a “Save As HTML” feature of the word processing software, as known in the art. This creates an HTML-type electronic file embodying the information content 205 and saves it at a selected location on the personal computer 20a, 20b or a connected network (not known), etc. In connection with selection of the “Save As HTML” feature of the word processor software, the word processor software automatedly inserts appropriate HTML tags 212 among the document text, etc., to create an HTML document 220 corresponding to the document 200 of FIG. 5, as shown in FIG. 6. This is particularly easy for even a relatively inexperienced computer user, and therefore may be performed by an individual without any computer programming experience.

A unique identification (ID) code is then provided for the PDA-executable application, as shown at step 134. This ID code is a four digit identification code that will identify the application, and that is required by Palm® OS or similar PDA OS for all PDA applications, in order to be recognized, tracked, etc. by the PDA OS, as is known in the art.

Next, the HTML document is converted to precompiler code, as shown at step 136. This step involves parsing the HTML document (file) to remove the HTML tags and encode ASCII text from the HTML document into binary values that relate to the ASCII characters/character sets. This step further involves inserting appropriate C++ code and then formatting all such code to ensure that string lengths are no longer than 256 characters long per line, that any programming reserved codes are “escaped” to ensure that the C++ compiler does not interpret the “escape” code as a programming code, etc. The precompiler code includes data representing the information content, including the information gathered from the conference.

A precompiling package is then created, as shown at step 138. The precompiling package includes the precompiler code from step 136 and all resources necessary for compiling. For example, such resources include a header file, a resources file and an environment variables file, as is typical for compiling. Additionally, such resources include the viewer software that will be incorporated into the PDA-executable application for viewing the information content. Accordingly, the precompiling package includes the information content developed to include information from an ongoing conference and the necessary viewer software for displaying the information content via a PDA device, but in a precompiled state, such that it is not yet integrated into a PDA-executable application.

Finally, the precompiling package is compiled and linked to create a single PDA-executable application file (e.g. a *.prc file) including the information content and viewer software for displaying the information content via a PDA, as shown at steps 140, 141. The compiling and linking processes are typical of those known in the art, and may be performed using conventional compiling and linking software, such as Code Warrior® software, which may be provided on the personal computer 20a. 20b. Accordingly, a single PDA-executable application file, including both information content including information gathered from a conference, and viewer software for displaying the information content via a PDA, is created for distribution via a beaming station at a conference, etc. The file may then be shared with conference attendees, and among conference attendees and others, without any need for additional viewer software, etc.

It should be noted that the PDA-executable application is compiled and linked to include a checksum reflecting the compiled state of the application. For example, when the application file is created, the number of characters are counted and the position of specific characters are mapped into a key. When the application is launched this key is verified against the binary code to ensure that all of the original characters are present, that no additional characters are present, that certain characters are in the same position as when the resource was compiled, etc. This ensures that the file was not subsequently edited after compiling. As known in the art, a checksum may be created and embedded/incorporated into an executable application such that any subsequent modification to the application can be later detected. This is of particular importance here to prevent modification of the underlying information content, if desired. If modification is attempted, a checksum verification process that is performed every time the application is executed/about to be executed will abort the execution of the application, and therefore prevent the display of the modified information content. It may be advantageous to preserve the integrity of the information content, particularly when an individual recipient having the PDA-executable application on a PDA may transmit a copy of the application to another individual's PDA, to promote viral-type distribution of the information content. Including a checksum is a known/automatic feature of such code development software, and such checksum verification, is well known in the art.

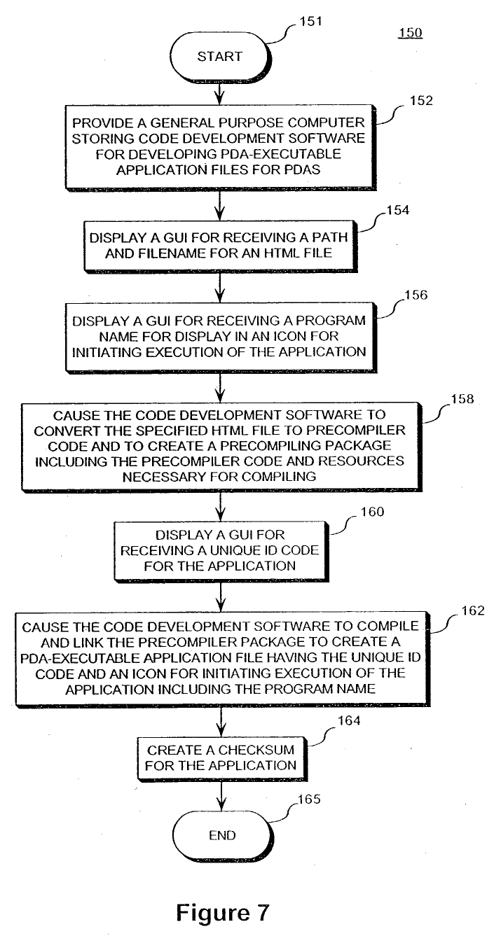

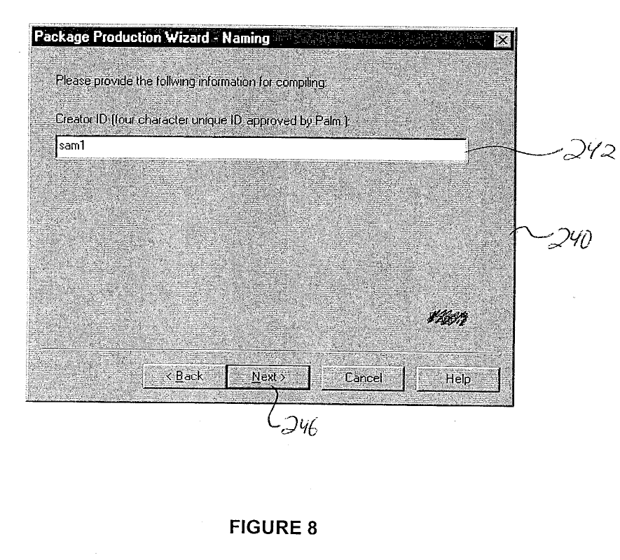

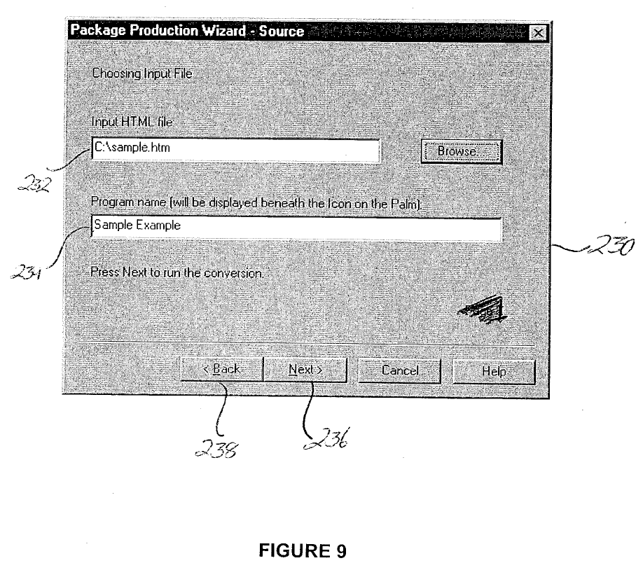

In a preferred embodiment, the method steps of FIG. 4 are implemented via software running on a personal computer 20a, 20b to provide a GUI to guide a relatively inexperienced computer user, e.g. an average computer user, through a PDA-application development process that is typically complex and requires a professional code developer. A method for providing such a GUI interface is provided in FIG. 7, and exemplary windows of such a GUI interface are shown in FIGS. 8 and 9.

Referring now to FIGS. 7-9, the method begins with providing a general purpose computer 20a, 20b (FIG. 1) storing code development software, such as Code Warrior®, for developing PDA-executable application files for PDA devices, as shown at step 152.

Next, a GUI window 230 is displayed via a video display device of the personal computer 20a, 20b, to prompt a user to input a computer/network path and filename indicating where the HTML file containing the information content for incorporation into the PDA-executable application can be found. The window 230 includes a text entry field 232 for receiving input from a user. The HTML file thus identified is the HTML file created to include the desired information content, that was developed in step 132 of FIG. 4.

Also displayed is a GUI window for receiving a program name for display in an icon on a PDA display screen for initiating execution of the PDA-executable application, as shown at step 156. In the example of FIG. 8, the same GUI window 230 is used but an additional text entry field 234 is provided for receiving corresponding input from the user.

As is typical of “wizard” type software implemented GUI's, Next and Back navigation buttons 236, 238 are provided to enable navigation through the GUI driven application development process.

Next, the method includes causing the code development software stored on the personal computer 20a, 20b to convert the specified HTML file to precompiler code, and to create a precompiling package including the precompiled code and resources necessary for compiling, as shown at step 158 and discussed above with reference to steps 136 and 138 of FIG. 4. Normally, these steps are performed by an experienced computer programmer by copying the textual information as string lists and creating a linked list of strings to formulate paragraphs of text. This requires knowledge of C++ and the creation of software code to enable the C++ compiler to interpret the code. This must be performed properly to allow the software to invoke the stand-alone code development software in accordance with the present invention. A subsequent GUI window or message (not shown) may be displayed to confirm that this step has been performed successfully.

As shown at step 160, a GUI window 240 is then displayed via a video display device of the personal computer 20a, 20b, to prompt a user to input a four character unique ID code for identifying the PDA application, as discussed above with reference to step 134 of FIG. 4. The window 240 includes a text entry field 242 for receiving corresponding input from a user.

Finally, the method involves causing the stand-alone code development software to compile and link the precompiler package to create a PDA-executable application file having the specified unique ID code, and an icon for initiating execution of the application, including the specified program name, as shown at step 162 and discussed above with reference to step 140 of FIG. 4. This may be initiated by selecting the Next button 246 of GUI window 240, which initiates software in accordance with the present invention for manipulating the information identified using the code development software stored on the computer 20a, 20b. More specifically, information gathered via the GUI windows is interpreted, text is formatted within the C++ code, the unique ID is inserted within the C++ code, and the application name is formatted and inserted into the C++ code. All images that are to be linked into the application are read into memory and compiled within the application.

A next GUI window or message (not shown) may be displayed to confirm that this step has been performed successfully. This step causes creation and storage of a PDA-executable file, e.g. a *.prc file for Palm OS on the computer 20a, 20b or at a location on a connected network.

In accordance with the present invention, therefore, software is provided that provides GUI windows for guiding a user and that automates the code development/programming processes so that even an inexperienced computer user, i.e. an average computer user or someone other than a professional software code developer, can accomplish the task of creating a PDA-executable application, by following the simple steps and prompts from the GUI window(s).

The application file may then be transmitted to a participant's PDA device by a synchronization process discussed above (see FIG. 1), and then the file may be transmitted from the participant's PDA to the beaming station for subsequent distribution, to conference attendees's PDA's as discussed above with reference to FIG. 3.

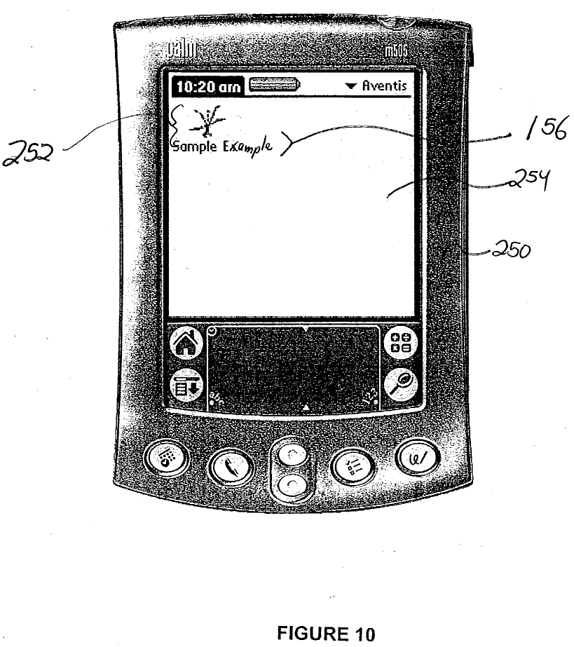

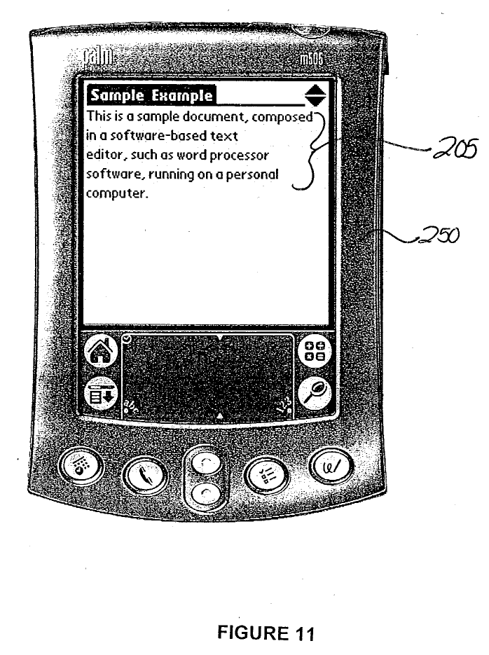

FIGS. 10 and 11 show an exemplary PDA device 250 displaying an application created in accordance with FIGS. 5-9. As shown in FIG. 10, once the PDA-executable application file is received and installed on a PDA device 250, an icon 252 is displayed via its display screen 254, and that icon includes the program name 256 provided in step 156. This icon is created and displayed as known in the art, and is a result of the manner in which the application file is created. Once the icon 252 is selected by a PDA user, the application file is executed by the PDA 250 to display the information content 205 prepared in step 132 of FIG. 4, as shown in FIG. 11. By way of example, the particular icon graphic may be determined by the software, the software may be configured to use a graphic having a certain file name, and a file with that file name may be provided by an operation of the software and be treated as a resource for compiling, etc.

As well known in the art, an electronic device, such as PDAs 30, 40a, 40b, 40c or a personal computers 20a, 20b, includes a general purpose microprocessor and a bus employed to connect and enable communication between the microprocessor and the components of the electronic device in accordance with known techniques. The electronic device typically includes an interface adapter, which connects the microprocessor via the a bus to one or more interface devices, such as a keyboard, mouse, touch sensitive screen, digitized entry pad, etc. and/or other interface devices. The bus also connects a display device, such as an LCD screen or monitor, to the microprocessor via a display adapter. The bus also connects the microprocessor to memory and long-term storage (collectively, “memory”) which can include a hard drive, diskette drive, tape drive, etc.

The electronic device may communicate with other electronic devices, computers or networks of computers, etc. via a data port. For example the data port may include a data receiving port and/or a data transmission port, each of which may include an infrared, wireless data transmission port. Additionally, the data port may include parallel, serial, or other well-known data ports, e.g. for synching to a personal computer, etc. All of these configurations, as well as the appropriate communications hardware and software, are well known in the art.

Software programming code, i.e. microprocessor executable instructions, embodying the present invention is typically stored in memory of some type, such as memory and/or storage of the personal computers 20a, 20b. Accordingly, the personal computer 20a, 20b stores in its memory and/or storage (collectively, “memory”), microprocessor executable instructions including computer readable instructions stored in the memory and executable by the microprocessor to: display a first graphical user interface (GUI) window having a first text entry field for receiving a path and filename of an HTML file including the information content; to convert the HTML document to precompiler code; to display a second GUI window having a second text entry field for receiving a program name for the application file; to display a third GUI window having a third text entry field for receiving a unique identification code for the application file; to create a precompiling package including the precompiler code and additional resources necessary for compiling; and to compile and link the precompiling package to create a PDA-executable application file including the information content and capable of displaying the information content via a PDA.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for rapid distribution of information comprising:
gathering information from a conference;
preparing information content incorporating the information gathered from the conference;
creating an electronic file including the information content, the electronic file being compatible with personal digital assistant (PDA) computing devices;
configuring a beaming station to transmit the electronic file; and
transmitting the file from the beaming station for receipt by a PDA device.

2. The method of claim 1, wherein the conference is in progress while information is gathered.

3. The method of claim 1, wherein the conference was in progress before the information is gathered.

4. The method of claim 1, wherein the electronic file is a data file formatted for interpretation by corresponding viewer software to display the information content via a PDA device.

5. The method of claim 1, wherein the electronic file is a PDA-executable application file including the information content and viewer software to display the information content via a PDA device.

6. The method of claim 5, wherein the electronic file comprises a checksum for preserving the integrity of the electronic file.

7. The method of claim 1, wherein creating the electronic file comprises:
preparing a hypertext markup language (HTML) document embodying the information content;
providing a unique identification code to identify an application embodying the information;
converting the HTML document to precompiler code;
creating a precompiling package including the precompiler code and additional resources necessary for compiling;
compiling and linking the precompiling package to create a PDA-executable application file including the information content and capable of displaying the information content via a PDA.

8. The method of claim 7, wherein the compiling and linking is performed by code development software running on a general purpose computer.

9. The method of claim 7, wherein the HTML document is prepared using word processor software running on a general purpose computer.

10. The method of claim 7, further comprising:
displaying a first graphical user interface (GUI) window having a first text entry field for receiving a path and filename of the HTML document;
displaying a second GUI window having a second text entry field for receiving a program name for the application file; and
displaying a third GUI window having a third text entry field for receiving a unique identification code for the application file.

11. The method of claim 1, wherein configuring a beaming station to transmit the electronic file comprises:
transmitting the file from a personal computer to a participant's' PDA device to store the file on the PDA device; and
transmitting the file from the participant's PDA device to the beaming station.

12. A method for developing a PDA-executable application file for displaying information content, the method comprising:
preparing a hypertext markup language (HTML) document embodying the information content;
providing a unique identification code to identify the application file;
converting the HTML document to precompiler code;
creating a precompiling package including the precompiler code and additional resources necessary for compiling;
compiling and linking the precompiling package to create a PDA-executable application file including the information content and capable of displaying the information content via a PDA.

13. The method of claim 12, wherein the compiling and linking is performed by code development software running on a general purpose computer.

14. The method of claim 12, wherein the HTML document is prepared using word processor software running on a general purpose computer.

15. The method of claim 12, further comprising:
displaying a first graphical user interface (GUI) window having a first text entry field for receiving a path and filename of the HTML document;
displaying a second GUI window having a second text entry field for receiving a program name for the application file; and
displaying a third GUI window having a third text entry field for receiving a unique identification code for the application file.

16. A computer readable medium for developing a PDA-executable application file for displaying information content, the computer readable medium comprising computer readable instructions for:
displaying a first graphical user interface (GUI) window having a first text entry field for receiving a path and filename of an HTML file including the information content;
converting the HTML document to precompiler code;
displaying a second GUI window having a second text entry field for receiving a program name for the application file;
displaying a third GUI window having a third text entry field for receiving a unique identification code for the application file;
creating a precompiling package including the precompiler code and additional resources necessary for compiling; and
compiling and linking the precompiling package to create a PDA-executable application file capable of displaying the information content via a PDA.

17. The computer readable medium of claim 16, wherein the application file is associated with the unique identification code, and is PDA-executable to create an icon including the program name for initiating execution of the application file.

18. The computer readable medium of claim 16, wherein the application file comprises a checksum for preserving the integrity of the application file.

19. A general purpose computer for developing a PDA-executable application file for displaying information content, the general purpose computer comprising:
a microprocessor;
a memory operatively connected to the microprocessor;
a data transmission port operatively connected to the microprocessor;
first computer readable instructions stored in the memory and executable by the microprocessor to display a first graphical user interface (GUI) window having a first text entry field for receiving a path and filename of an HTML file including the information content;
second computer readable instructions stored in the memory and executable by the microprocessor to convert the HTML document to precompiler code;
third computer readable instructions stored in the memory and executable by the microprocessor to display a second GUI window having a second text entry field for receiving a program name for the application file;
fourth computer readable instructions stored in the memory and executable by the microprocessor to display a third GUI window having a third text entry field for receiving a unique identification code for the application file;
fifth computer readable instructions stored in the memory and executable by the microprocessor to create a precompiling package including the precompiler code and additional resources necessary for compiling; and
sixth computer readable instructions stored in the memory and executable by the microprocessor to compile and link the precompiling package to create a PDA-executable application file including the information content and capable of displaying the information content via a PDA.

20. A graphical user interface for developing a PDA-executable application file using a general purpose computer having a microprocessor, a memory operatively connected to the microprocessor and a data transmission port, said graphical user interface comprising:
a first text entry field for receiving a path and filename of an HTML file embodying the information content;
a second GUI window having a second text entry field for receiving a program name for the application file;
a third GUI window having a third text entry field for receiving a unique identification code for the application file;
a first user-selectable button to cause automated conversion of the HTML document to precompiler code;
a second user-selectable button to create a precompiling package including the precompiler code and additional resources necessary for compiling; and
a third user-selectable button to cause compiling and linking the precompiling package to create a PDA-executable application file including the information content and capable of displaying the information content via a PDA.

21. The graphical user interface of claim 20, wherein the user-selectable button to cause compiling and linking is configured to initiate compiling and linking of the precompiling package by code development software running on the general purpose computer.
